(19) United States
(12) Patent Application Publication
(10) Pub. No.: US 2026/0329262 A1
(43) Pub. Date: Oct. 22, 2026

(54) Partial Trajectory Regression for Sequential Causal Analysis

(71) Applicant: International Business Machines Corporation, Armonk, NY (US)

(72) Inventors: Kohei Miyaguchi, Tokyo (JP); Masao Joko, Tokyo (JP); Tsuyoshi Ide, Harrison, NY (US)

(21) Appl. No.: 19/185,367

(22) Filed: Apr. 22, 2025

(51) Int. Cl. G05B 19/418

(52) U.S. Cl. CPC G05B 19/41875; G05B 19/41865; G05B 2219/45031

(57) ABSTRACT

A computer system comprises a processor set, a set of one or more computer-readable storage media, and program instructions stored in the set of one or more storage media. The program instructions cause the processor set to receive a trajectory, wherein the trajectory comprises a sequence of processes for manufacturing semiconductor devices on a substrate. The program instructions cause the processor set to predict defect densities for the sequence of processes in the trajectory using a prediction system that predicts the defect densities for the sequence of processes in the trajectory using a partial trajectory regression. The program instructions cause the processor set to determine attribution scores for the sequence of processes in the trajectory using the defect densities predicted by the prediction system, wherein the attribution scores indicate a responsibility of processes in the sequence of processes for a defect density of the substrate.

### BACKGROUND

The disclosure relates generally to manufacturing products and more specifically manufacturing semiconductors on wafers. Still more particularly, the present disclosure relates to identifying causes of defect densities for wafers with semiconductors resulting from sequential processes used to manufacture semiconductors.

semiconductor device fabrication, a process trajectory, also known as processing route or path, defines a sequence of steps used to form integrated circuits on silicon wafers. Each of these processes is comprised of operations that can include, for example, polishing, ion implantation, fusion, etching, deposition, photolithography, cleaning, metallization, annealing, and other processes.

The cost of manufacturing semiconductor devices has continued to increase with ongoing technological advancements. In modern semiconductor fabrication facilities (fabs), the entire manufacturing process spans several months per wafer and requires specialized equipment and expensive materials.

In semiconductor manufacturing, a significant challenge arises when wafers that have already undergone multiple processing steps are later found to be defective due to a yield-degrading operation. This results in wasted time, energy, and materials not only for the affected wafers, but also for others processed before the issue is identified.

To address this issue, process-limited yields (PLY s), which are intermediate yield assessments, are conducted. These assessments are made after key processing steps such as gate formation. The results of these assessments can be used to evaluate the performance of specific process segments, particularly during research and development. While PLY s help isolate and identify steps that contribute to yield loss, these types of assessments are typically obtained through microscope-based inspection and followed by specialized defect classification analysis. This process can take hours or even days, depending on tool availability.

As a result, PLY checkpoints are usually placed only after major microstructures are formed, such as gates. Despite the introduction of intermediate inspection points, each PLY reflects the cumulative effect of tens or even hundreds of upstream processes, making it difficult to pinpoint the exact source of yield degradation. Currently, root-cause analysis of wafer defects often relies on a semi-brute-force approach, where large numbers of wafers are processed under varying process conditions to reproduce and investigate the issue.

### SUMMARY

According to one illustrative embodiment, a computer system is provided that comprises a processor set, a set of one or more computer-readable storage media, and program instructions stored in the set of one or more storage media. The program instructions cause the processor set to receive a trajectory, wherein the trajectory comprises a sequence of processes for manufacturing semiconductor devices on a substrate. The program instructions cause the processor set to predict defect metrics for the sequence of processes in the trajectory using a partial trajectory regression model system that predicts the defect metrics for the sequence of processes in the trajectory using a partial trajectory regression. The program instructions cause the processor set to determine attribution scores for the sequence of processes in the trajectory using the defect metrics predicted by the prediction system, wherein the attribution scores indicate a responsibility of processes in the sequence of processes for a defect metric for the substrate. According to other illustrative embodiments, a method and a computer program product for predicting defect metrics are provided.

According to another illustrative embodiment, a semiconductor manufacturing system is provided comprising semiconductor manufacturing equipment that operates to perform a sequence of processes; a prediction system trained to output attribution scores for sequences of processes in trajectories; and a controller. The controller receives a trajectory, wherein the trajectory comprises a sequence of processes for the semiconductor manufacturing equipment to manufacture semiconductor devices on a wafer. The controller determines attribution scores for the sequence of processes in the trajectory using defect densities predicted by the prediction system, wherein the attribution scores indicate a responsibility of processes in the sequence of processes for a defect metric for the wafter. The controller controls operation of the semiconductor manufacturing equipment using a number of changes to the sequence of processes based on the attribution scores.

### BRIEF DESCRIPTION OF THE DRAWINGS

FIG. 1 is an illustration of partial trajectories in accordance with an illustrative embodiment;

FIG. 2 is an illustration of a constrained recurrent neural network for implementing partial trajectory regression in accordance with an illustrative embodiment;

FIG. 3 is a plot of a cumulative attribution scores for a specific wafer is depicted in accordance with an illustrative embodiment;

FIG. 4 is a block diagram of a computing environment in accordance with an illustrative embodiment;

FIG. 5 is a block diagram of a semiconductor manufacturing environment in accordance with an illustrative embodiment;

FIG. 6 is a block diagram of a partial trajectory regression model that performs partial trajectory regressions in accordance with an illustrative embodiment;

FIG. 7 is a flowchart of a process for defect attribution in accordance with an illustrative embodiment;

FIG. 8 is a flowchart of a process for identifying processes responsible for defect metrics in accordance with an illustrative embodiment;

FIG. 9 is a flowchart of a process for adjusting manufacturing semiconductors on wafers using an adjusted process in accordance with an illustrative embodiment;

FIG. 10 is a flowchart of a process for a partial trajectory regression model in accordance with an illustrative embodiment;

FIG. 11 is a flowchart of a process for training a partial trajectory regression model to predict defect densities using partial trajectories in accordance with an illustrative environment; and

FIG. 12 is a flowchart of a process for controlling semiconductor manufacturing equipment in accordance with an illustrative embodiment.

### DETAILED DESCRIPTION

The illustrative embodiments recognize and take into account one or more different considerations in manufacturing semiconductors on wafers as described herein. For example, localizing the root causes of wafer defects is critical yet challenging due to multiple factors, including complex dependencies between processes, the heterogeneity of individual processes and recipes, and dynamic variations in processing routes. These challenges complicate the application of generic machine learning (ML) tools.

Two approaches have emerged using data-driven defect diagnosis. The first approach treats defect diagnosis as a by-product of cross process virtual metrology (VM) modeling. Regularized linear regression combined with variable selection techniques is commonly used. However, linear models struggle to capture complex nonlinear relationships across heterogeneous fabrication processes. Furthermore, defect attribution based on linear models essentially reduces to variable-wise correlation analysis, which is known to yield weak attribution signals.

The second approach involves leveraging explainable artificial intelligence (XAI) techniques to enhance more expressive deep-learning-based models. However, for cross-process defect attribution, existing methods still fail to account for the sequential nature of semiconductor processes and rely on arbitrarily chosen baseline points. Ironically, these approaches attempt to address the black-box nature of deep learning models by employing XAI techniques as yet another black-box tool.

Techniques are present that improve the interpretability of machine learning models under the umbrella of explainable artificial intelligence (XAI). One category is additive explanation methods, which provide mathematically justified decompositions of a model's output into individual contributions of input variables. Other XAI techniques include gradient-based methods and attention-based methods.

Several XAI methods have been proposed for sequential input variables, such as wafer processing routes. The integration of model-agnostic XAI techniques with advanced quality prediction models is a trend in semiconductor analytics, aiming to balance predictive power with interpretability. These various XAI methods include the Shapley value (SV).

However, as mentioned above, XAI algorithms are black-box tools, paying little attention to the validity of its modeling assumptions. In fact, SV disregards both the sequential nature of semiconductor processes and the wafer-lot hierarchy, limiting its effectiveness in root cause analysis for manufacturing applications.

For at least these reasons, it is desirable to have improvements to root cause analysis (RCA) that can identify specific processes that are the cause of undesired defect densities. More specifically, it is desirable to provide improvements to input attribution for deep neural networks for RCA.

In semiconductor manufacturing, properly accounting for the sequential nature of wafer processing routes is essential. However, most current techniques rely on relatively simple univariate correlation analysis combined with linear regression, largely disregarding the sequential dependencies inherent in manufacturing processes.

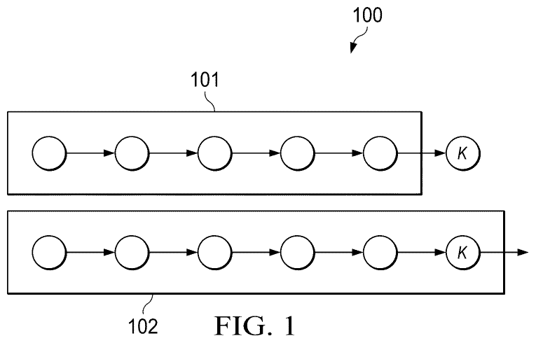

Thus, the illustrative examples provide a causal analysis of wafer defects that traces defects back to specific operations within the sequential process history. In these examples, improved representation learning models are provided to trajectories. With reference to FIG. 1, an illustration of partial trajectories is depicted in accordance with an illustrative embodiment. As depicted, partial trajectories 100 are examples of two partial trajectories. A partial trajectory includes sequential processes up to a selected process within the trajectory.

For example, partial trajectory 102 starts at a first process and includes sequential processes after the first process up to a target process k. Target process k is the last process in partial trajectory 102. Partial trajectory 101 includes the same sequential processes as partial trajectory 102, excluding the target process k.

A prediction model implementing partial trajectory regression (PTR) quantifies a degree of causal intervention of the target process k on the observed defect density. This prediction model is also referred to as a partial trajectory regression model and predicts defect densities for these partial trajectories. In this example, a defect density is predicted for partial trajectory 101 and a defect density is predicted for partial trajectory 102.

The predicted defect densities for these two partial trajectories can be compared to each other to quantify the degree of causal intervention for target process k, which is the target process of interest for the defect density. This technique illustrated by partial trajectories 100 facilitates the identification of specific processes responsible for high defect densities, thereby supporting quality improvement initiatives.

Techniques are present that focus on leveraging machine learning with accumulated data for root cause analysis in the manufacturing industry. The illustrative examples, align with the Factors Problem category, utilizing Location-Time data.

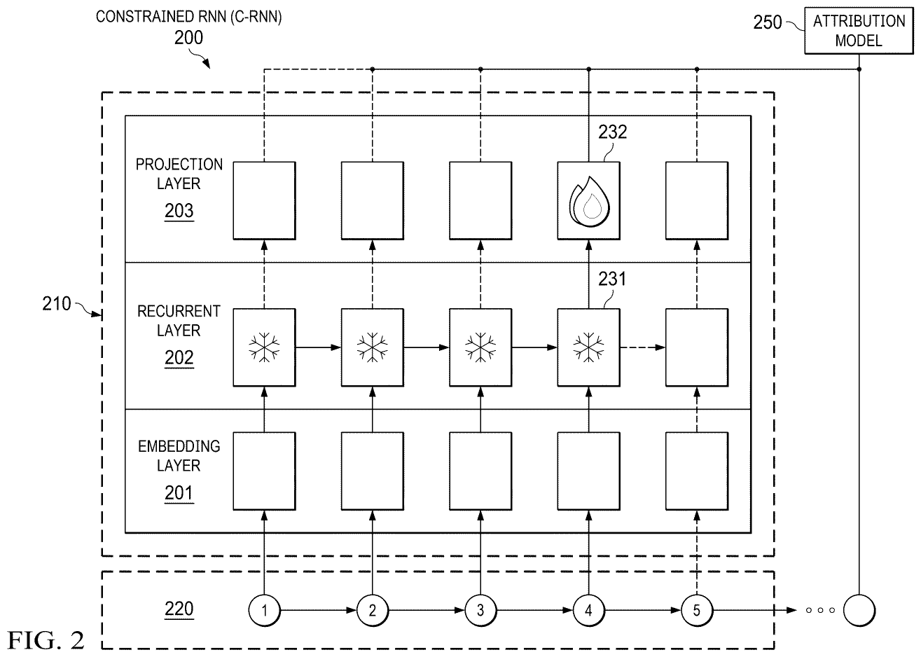

To handle the diversity of process trajectories and capture implicit similarities, some current techniques employ unsupervised learning techniques such as clustering and principal component analysis. The illustrative example uses a more end-to-end approach that integrates a preprocessing step directly into the embedding layer, such as embedding layer 201 described in FIG. 2 below. The preprocessing is performed using Proc2V ec, which is an embedding technique that represents individual processes in the wafer manufacturing history as vectors while incorporating inter-process similarities.

Further, natural language processing (NLP), such as in Word2V ec and token embeddings in Transformer models have used techniques where individual processes are analogous to words/tokens, and process histories correspond to sentences/documents. However, applying embedding techniques, such as Proc2V ec, to analyze wafer processing histories have not been used.

In the illustrative example, the comparison of defect densities for partial trajectories 100 depicted in FIG. 1 enables calculation of attribution scores that can be used to identify processes responsible for an undesired defect density in a trajectory.

In one illustrative example, the defect-cause attribution score for each process in the process history is computed, given a training dataset:

$${D}_{train} := {\{ ( {y}^{( n )} , {ξ}^{( n )} ) \}}_{n = {1}^{′}}^{N} \qquad ( 1 )$$

where y is defect density and ξ is the trajectory, and the superscript (n) denotes that the quantity belongs to the n-th wafer. A process trajectory ξ is a sequence of process attributes and timestamps as follows:

ξ=((x₁,t₁), . . . ,(x_{L},t_{L})) (2)

where L is the number of process steps included in ξ. The goal of the prediction task is to find a function f(ξ) such that it gives a prediction of defect density for a given process trajectory ξ that is not included in Dₜᵣₐᵢₙ in general. This training data set can be used to train a partial trajectory regression model. With this training the partial trajectory regression model can perform the prediction function f(ξ) to predict the defect densities for partial trajectories.

With attribution analysis, the attribution task is to find a function αₖ(ξ), which computes the responsibility score for the k-th process on the process trajectory ξ. This analysis can make use of a trained prediction function f(ξ) implemented in the partial trajectory regression model in which the function predicts defect densities for partial trajectories.

The illustrative examples take into account and recognize that semiconductor analytics has unique characteristics. For example, although Equation (1) suggests a dataset comprising independent samples, wafers are not necessarily independent due to lot- and batch-based processing. Additionally, within each wafer's processing route, an inherent ordering among individual processes exists, making this problem fundamentally different from standard tabular data analysis. These characteristics render many current machine learning tools ineffective, as most assume sample independence and permutation invariance among variables. Furthermore, in the yield ramp-up phase, where multiple processing recipes are tested simultaneously, the diversity of processing routes is potentially large. This further complicates model training, as the effective sample size, defined as the number of wafers per unique processing or measurement condition, may be extremely small, possibly as low as one.

Turning to FIG. 2, an illustration of a constrained recurrent neural network (C-RNN) for implementing partial trajectory regression is depicted in accordance with an illustrative embodiment. In this illustrative example, C-RNN 200 predicts defect densities for partial trajectories using partial trajectory regression.

C-RNN 200 generates predictions of defect densities for partial trajectories using partial trajectory regression. These defect densities predicted for the partial trajectories can be used to calculate an attribution score for each process in the process history for a trajectory. As depicted in FIG. 2, C-RNN 200 is comprised of embedding layer 201, recurrent layer 202, and projection layer 203. In this example, each of these layers is comprised of cells 210.

Embedding layer 201 provides process embedding and is formed from one or more embedding layers. In this depicted example, embedding layer 201 receives a trajectory in the form of a string. This string describes the sequential processes in a trajectory and the attributes for those processes in the trajectory. Embedding layer 201 creates process vectors that represent the processes in the trajectory. In this illustrative example, the process vector is a numerical representation of a process and its attributes. Embedding layer 201 can implement various processes to create vector representations of the processes. In this example, embedding layer 201 can be implemented using Proc2Vec. Embedding layer 201 can handle a diversity of trajectories and capture implicit similarities between the description of processes in trajectories.

In this illustrative example, Proc2V ec is a function that generates a vector representation for each process using a kernel embedding technique. In kernel embedding, data points such as words are mapped into a continuous vector space using kernel methods. These kernel methods are machine learning techniques that transform data into a higher-dimensional feature space using kernel functions that compute the similarity between two data points in an implicit high-dimensional space without explicitly mapping them.

Common process attributes across different processes are extracted. Process attributes can be available from the manufacturing execution system. These process attributes can include at least one of equipment identifiers, recipe identifiers, tool types, photo layer identifiers, and route identifiers, or other process attributes.

These process attributes are concatenated into a single string representing each process:

(process token)=eqp⊕recipe⊕tool_type⊕photo_layer⊕route⊕ (3)

where ⊕ denotes concatenation with a suitable separator.

In this depicted example, based on the string representation a dictionary of the tokens is constructed. Let V_{d} is the size of the vocabulary, i.e., the number of unique tokens. For the dictionary, a kernel matrix is constructed between processes based on the string representation. The kernel matrix K∈ [symbol] ^{V}^{_{d}}^{×V}^{_{d}}, where K_{i,j} is the similarity between token i and token j.

One the kernel matric is computed, the vector representation of process i is obtained as follows:

$${x}_{i} = {( \sqrt{{λ}_{1}} {v}_{i}^{( 1 )} , … , \sqrt{{λ}_{k}} {v}_{i}^{( k )} , … , \sqrt{{λ}_{D}} {v}_{i}^{( D )} )}^{⊤} \qquad ( 4 )$$

where λₖ is the k-th largest eigenvalue of K, and

$${v}_{i}^{( k )} \qquad ( 4 )$$

is the i-th element of the eigenvector corresponding to λₖ. D is the embedding dimensionality as a hyperparameter. This mapping from process i to its vector representation xᵢ is referred to as Proc2Vec. Thus, using Proc2V ec, a process trajectory ξ is represented as an ordered set of processes with associated process completion times.

In this illustrative example, recurrent layer 202 implements regression modeling using process vectors generated by embedding layer 201. With processes having been converted from a string form into D-dimensional vectors, a predictive model is implemented for defect density y as a function of the sequence of the process vectors. Recurrent layer 202 can handle the variable length of trajectories, making this trajectory regression technique different from current regression techniques.

Recurrent layer 202 can create partial trajectories used to predict defect densities. In these examples, partial trajectories are generated by incrementally including a next process in the sequences of processes. The generation of partial trajectories can be performed using a function Route2V ec implemented in recurrent layer 202. The Route2V ec converts the entire trajectory, represented as an ordered set of process vectors, into a trajectory vector representation. In this illustrative example, a constrained-recurrent neural network (C-RNN) is used where each cell operates as:

zₖ=Cell(zₖ₋₁,xₖ,tₖ) (5)

where zₖ is the vector representation of the partial trajectory up to the k-th process from the first process. As a result, the vector representation of the full trajectory of ξ⁽ⁿ⁾ is obtained as

$${z}^{( n )} := {z}_{{L}^{( n )}}^{( n )} .$$

In these examples, this mapping from a (partial or full) trajectory zₖ (k=1, . . . , L) is referred to as route2vec.

In the illustrative examples, a cell architecture for cells 210 is used as follows:

zₖ=ψ(tₖ,tₖ₋₁)xₖ+zₖ₋₁ (6)

where ψ(⋅,⋅) is a temporal mapping function set to log₁₀(1+.). Equation (6) can be extended to more expressive models such as multi-layer perceptrons (MLP).

Projection layer 203 provides a prediction of the defect density based on vectors for the partial trajectories received from recurrent layer 202. Thus, projection layer 203 outputs a defect density for each partial trajectory received from recurrent layer 202. In these examples, a defect density represents the defect density present after the last process in the sequence of processes in a partial trajectory. As a result, defect densities can be used to determine which process or processes are responsible for the defect density of the input trajectory.

The regression function in recurrent layer 202 defines a function to predict defect density y from ξ. Since route2vec converts trajectories of varying lengths into fixed-dimension vectors, the prediction function can be formulated as:

ƒ(zₖ)=MLP(zₖ) (7)

where MLP denotes a multi-layer perceptron. In this example, a fully connected network is used without hidden layers. This network defines a linear prediction function. Further, notation for the function f(⋅) can be for both a full trajectory and partial trajectories. The function f(⋅) in recurrent layer 202 is trained to minimize a properly regularized squared loss such as:

$$L := \frac{1}{2 N} {\sum }_{n = 1}^{N} {\sum }_{k = 1}^{{L}^{( n )}} \frac{1}{{L}^{( n )}} {( {y}^{( n )} - f ( {z}_{k} ) )}^{2} + v {‖ θ ‖}_{1} \qquad ( 8 )$$

where θ is the model parameters in f(⋅) and ∥⋅∥₁ is the l₁-norm. v is the regularization strength and is treated as a hyperparameter. The inner summation represents data augmentation for numerical stability.

In this example, constrained recurrent neural network 200 provides an ability to receive partial trajectories as an input trajectory. To quantify the influence of the k-th process, a determination can be made as to whether a significant difference in the prediction outcome between the partial trajectories zₖ and zₖ₁ is present. For example, determination can be made as to whether a difference in the prediction of defect densities between the partial trajectories exceeds a threshold. This threshold is set as one in which the difference is sufficiently significant such that the k-th process is considered responsible for the defect density for the wafer. This comparison between two counterfactual inputs measures the potential outcome when including process k.

In this example, attribution model 250 can be used to process the outputs from constrained recurrent neural network 200 to determine respective attribution scores for the processes in a trajectory. Attribution model 250 can receive the defect densities output by projection layer 203. The attribution score for a process can be directly calculated as the difference of defect densities between a first trajectory with processes up to, but excluding, the process in question, and a second trajectory with processes up to and including the process.

This quantification can be made following Rubin's potential outcome framework, which is also referred to as Rubin Causal Model (RCM). The attribution model quantifies the causal intervention of process kas follows:

αₖ(ξ)=ƒ(zₖ)−ƒ(zₖ₋₁) (9)

where k is the process index and ƒ(zₖ) is the defect density prediction for partial trajectory k and ƒ(zₖ₋₁) is the defect density prediction for the partial trajectory without process k. This equation defines the attribution score of the k-th process in trajectory ξ. This attribution score satisfies the following additive property:

Theorem III.1 (Additive Property of PTR). The PTR attribution score satisfies the additive property:

$${\sum }_{l = 1}^{k} {α}_{l} = f ( {z}_{k} ) - f ( {z}_{0} ) \qquad ( 10 )$$

This proof is obtained from directly summing individual contributions:

$${\sum }_{l = 1}^{k} {α}_{l} = [ f ( {x}_{k} ) - f ( {z}_{k - 1} ) ] + [ f ( {z}_{k - 1} ) - f ( {z}_{k - 2} ) ] + … + [ f ( {z}_{1} ) - f ( {z}_{0} ) ] = f ( {z}_{k} ) - f ( {z}_{0} ) \qquad ( 11 )$$

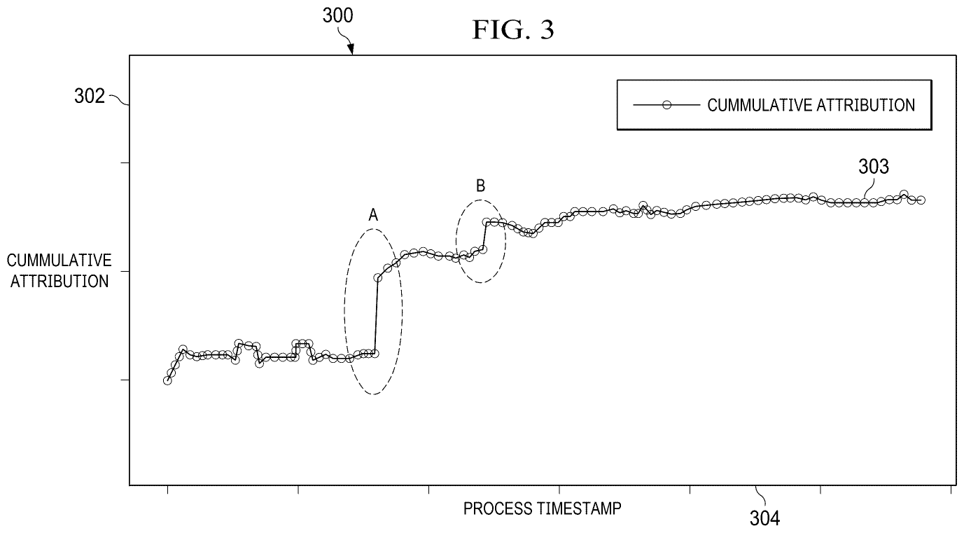

This additive property significantly enhances the interpretability of the attribution score as shown below in FIG. 3.

In the example in FIG. 2, trajectory 220 is input into embedding layer 201. In this example, trajectory 220 includes process 1, process 2, process 3, process 4, and process 5. Each of these processes are converted into process vectors by cells 210 in embedding layer 201.

These process vectors are sent to cells 210 recurrent layer 202, which uses the process vectors to create partial trajectory vectors for partial trajectories. For example, the cells up through cell 231 in recurrent layer 202 compute a partial trajectory that includes processes up to and including process 4.

A cell operates as follows:

$${z}_{1 : k}^{( n )} = {z}_{1 : k - 1}^{( n )} + {log}_{10} ( {t}_{k}^{( n )} - {t}_{k - 1}^{( n )} ) {x}_{k}^{( n )} \qquad ( 12 )$$

### Where

$${x}_{k}^{( n )}$$

is the process vector of the k-th process,

$${z}_{1 : k - 1}^{( n )}$$

is the trajectory vector of the trajectory from first process up to the k−1 th process;

$$( {t}_{k}^{( n )} - {t}_{k - 1}^{( n )} )$$

are a difference in timestamps between k-th process and k−1-th process; k is the index for a process in a trajectory; nis the index for trajectories; and tare time stamps.

In this example, a selected cell receives a partial trajectory vector

$${z}_{1 : k - 1}^{( n )}$$

from one cell to the left of the selected cell and receives the process vector

$${x}_{k}^{( n )}$$

from another cell in a lower layer that is below the selected cell. The output from the selected cell is

$${z}_{1 : k}^{( n )}$$

which is the partial trajectory vector up to the k−1 process.

This definition for cells 210 enables recurrent layer 202 to handle partial trajectories since

$${z}_{1 : k}^{( n )}$$

can be through of as the internal state up to the k-th process. Equation (12) can be generalized into

$${z}_{1 : k}^{( n )} = {z}_{1 : k - 1}^{( n )} + ψ ( {t}_{k}^{( n )} - {t}_{k - 1}^{( n )} ) ϕ ( {x}_{k}^{( n )} ) ,$$

with φ, ψ being learnable function such as multi-layer perceptrons (MLPs).

With this example of recurrent layer 202, the learning parameter is not present. The above equation can be generalized to

$${z}_{1 : k}^{( n )} = {z}_{1 : k - 1}^{( n )} + ψ ( {t}_{k}^{( n )} - {t}_{k - 1}^{( n )} ) ϕ ( {x}_{k}^{( n )} ) ,$$

with φ, ψ being learnable functions such as MLPs (multi-layer perceptrons). The separation of the time duration is due to specific needs of semiconductor manufacturing. Leaving wafer unprocessed for a long time negatively can affect the final quality. This specific parameterization is one of the unique features in these illustrative examples.

In this example, projection layer 203 determines predicted defect densities for the trajectory vectors representing the partial trajectories. For example, cell 232 in projection layer 203 computes the defect density for the partial trajectory vector that includes processes up to and including process 4.

In this example, a prediction of a defect density output by cell 232 can be made for detection point 270. This detection point is a point in the process where defect densities are detected.

The illustration of C-RNN 200 in FIG. 2 is provided as an example of an implementation for a partial trajectory regression model that predicts defect metrics such as defect densities and is not meant to limit the manner in which other illustrative examples can be implemented. For example, although a single layer shown for projection layer 203, recurrent layer 202, and embedding layer 201, these different types of layers can include one or more layers in addition to the ones illustrated in some examples. Also, other types of prediction models can be implemented to handle partial trajectories using a partial trajectory regression in other illustrative examples.

With reference to FIG. 3, a plot of cumulative attribution scores for a specific wafer is depicted in accordance with an illustrative embodiment. As depicted, plot 300 shows changes in cumulative attribution scores from performing processes in a trajectory over time. In this example, x-axis 304 represents the process time stamp, and y-axis 302 represents the cumulative attribution score.

As shown in this graph, line 303 illustrates the cumulative attribution score for sequential processes over time as calculated as follows:

$${\sum }_{i = 1}^{k} {α}_{i} + f ( {z}_{0} ) \qquad ( 13 )$$

for a specific wafer at each time stamp τ where tₖ≤τ; αᵢ is the attribution score for the i-th process, i is an index, and ƒ(z₀) is initial defect density prior to the first process. In this example, cumulative attribution scores in line 303 can be calculated using Equation (13) and defect densities predicted for partial trajectories using a prediction model that implements partial trajectory regression.

Thus, plot 300 illustrates the progression from ƒ(z₀) (intercept) to ƒ(z), the final prediction based on the wafer's complete trajectory. Notable jumps are present at A and B in plot 300. In this example, these jumps correspond to unusually long waiting times at certain tools, suggesting potential root causes of high defect density. This example demonstrates how using partial trajectory regression effectively identifies problematic processes, providing actionable insights for root cause analysis.

With the identification of these two processes in plot 300, advanced process control (APC) can be enabled to improve the quality of wafers manufactured using the trajectory. This type of control can include making adjustments to attributes in a process such as recipe parameters for a specific processing tool in a process. These adjustments can be made in a semi-automated manner.

For example, an input including a sensor measurement from a processing tool (such as a polishing machine) can be used in advanced process control. The output is an amount of adjustment for certain key parameters, such as, e.g., the temperature of the chamber. A model that associates the input with the output is used in this example. Thus, while partial trajectory regression models in the examples do specify the exact adjustment values, the output from the partial trajectory regression models can be used to identify which processes should be examined using ACP. In this example, the wait time may be reduced to reduce the defect density.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

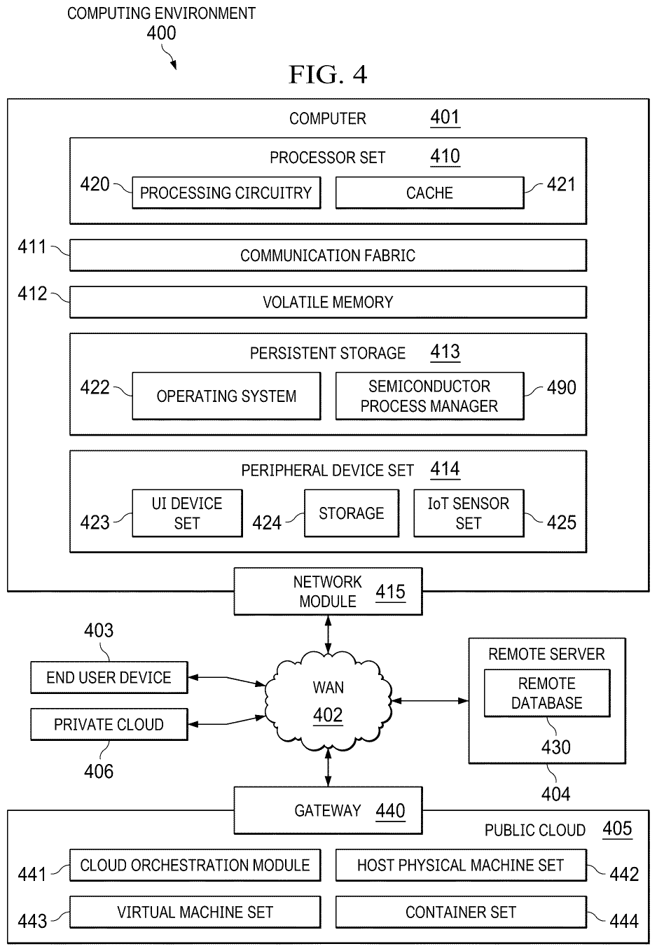

With reference now to the figures in particular with reference to FIG. 4, a block diagram of a computing environment is depicted in accordance with an illustrative embodiment. Computing environment 400 contains an example of an environment for the execution of at least some of the computer code involved in performing the inventive methods, such as semiconductor process manager 490. In addition to semiconductor process manager 490, computing environment 400 includes, for example, computer 401, wide area network (WAN) 402, end user device (EUD) 403, remote server 404, public cloud 405, and private cloud 406. In this embodiment, computer 401 includes processor set 410 (including processing circuitry 420 and cache 421), communication fabric 411, volatile memory 412, persistent storage 413 (including operating system 422 and semiconductor process manager 490, as identified above), peripheral device set 414 (including user interface (UI) device set 423, storage 424, and Internet of Things (IoT) sensor set 425), and network module 415. Remote server 404 includes remote database 430. Public cloud 405 includes gateway 440, cloud orchestration module 441, host physical machine set 442, virtual machine set 443, and container set 444.

COMPUTER 401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically computer 401, to keep the presentation as simple as possible. Computer 401 may be located in a cloud, even though it is not shown in a cloud in FIG. 4. On the other hand, computer 401 is not required to be in a cloud except to any extent as may be affirmatively indicated.

PROCESSOR SET 410 includes one, or more, computer processors of any type now known or to be developed in the future. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set may be located “off chip.” In some computing environments, processor set 410 may be designed for working with qubits and performing quantum computing.

Computer-readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 421 and the other storage media discussed below. The program instructions, and associated data, are accessed by processor set 410 to control and direct performance of the inventive methods. In computing environment 400, at least some of the instructions for performing the inventive methods may be stored in semiconductor process manager 490 in persistent storage 413.

COMMUNICATION FABRIC 411 is the signal conduction path that allows the various components of computer 401 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 412 is any type of volatile memory now known or to be developed in the future. Examples include dynamic type random access memory (RAM) or static type RAM. Typically, volatile memory 412 is characterized by random access, but this is not required unless affirmatively indicated. In computer 401, the volatile memory 412 is located in a single package and is internal to computer 401, but, alternatively or additionally, the volatile memory may be distributed over multiple packages and/or located externally with respect to computer 401.

PERSISTENT STORAGE 413 is any form of non-volatile storage for computers that is now known or to be developed in the future. The non-volatility of this storage means that the stored data is maintained regardless of whether power is being supplied to computer 401 and/or directly to persistent storage 413. Persistent storage 413 may be a read only memory (ROM), but typically at least a portion of the persistent storage allows writing of data, deletion of data and re-writing of data. Some familiar forms of persistent storage include magnetic disks and solid state storage devices. Operating system 422 may take several forms, such as various known proprietary operating systems or open source Portable Operating System Interface-type operating systems that employ a kernel. The code included in semiconductor process manager 490 typically includes at least some of the computer code involved in performing the inventive methods.

PERIPHERAL DEVICE SET 414 includes the set of peripheral devices of computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 423 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some embodiments, storage 424 may take the form of a quantum computing storage device for storing data in the form of qubits. In embodiments where computer 401 is required to have a large amount of storage (for example, where computer 401 locally stores and manages a large database) then this storage may be provided by peripheral storage devices designed for storing very large amounts of data, such as a storage area network (SAN) that is shared by multiple, geographically distributed computers. IoT sensor set 425 is made up of sensors that can be used in Internet of Things applications. For example, one sensor may be a thermometer and another sensor may be a motion detector.

NETWORK MODULE 415 is the collection of computer software, hardware, and firmware that allows computer 401 to communicate with other computers through WAN 402. Network module 415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 415 are performed on the same physical hardware device. In other embodiments (for example, embodiments that utilize software-defined networking (SDN)), the control functions and the forwarding functions of network module 415 are performed on physically separate devices, such that the control functions manage several different network hardware devices. Computer-readable program instructions for performing the inventive methods can typically be downloaded to computer 401 from an external computer or external storage device through a network adapter card or network interface included in network module 415.

WAN 402 is any wide area network (for example, the internet) capable of communicating computer data over non-local distances by any technology for communicating computer data, now known or to be developed in the future. In some embodiments, the WAN 402 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 403 is any computer system that is used and controlled by an end user (for example, a customer of an enterprise that operates computer 401), and may take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 401 through WAN 402 to EUD 403. In this way, EUD 403 can display, or otherwise present, the recommendation to an end user. In some embodiments, EUD 403 may be a client device, such as thin client, heavy client, mainframe computer, desktop computer and so on.

REMOTE SERVER 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data may be provided to computer 401 from remote database 430 of remote server 404.

PUBLIC CLOUD 405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 405 is performed by the computer hardware and/or software of cloud orchestration module 441. The computing resources provided by public cloud 405 are typically implemented by virtual computing environments that run on various computers making up the computers of host physical machine set 442, which is the universe of physical computers in and/or available to public cloud 405. The virtual computing environments (V CEs) typically take the form of virtual machines from virtual machine set 443 and/or containers from container set 444. It is understood that these V CEs may be stored as images and may be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware, and firmware that allows public cloud 405 to communicate through WAN 402.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 406 is similar to public cloud 405, except that the computing resources are only available for use by a single enterprise. While private cloud 406 is depicted as being in communication with WAN 402, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 405 and private cloud 406 are both part of a larger hybrid cloud.

CLOUD COMPUTING SERVICES AND/OR MICROSERVICES: Public cloud 405 and private cloud 406 are programmed and configured to deliver cloud computing services and/or microservices (not separately shown in FIG. 4). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to “as a service” technology paradigm where something is being presented to an internal or external customer in the form of a cloud computing service. As-a-Service offerings typically provide endpoints with which various customers interface. These endpoints are typically based on a set of A Pls. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (Saas) where software is centrally hosted and allocated on a subscription basis. SaaS is also known as on-demand software, web-based software, or web-hosted software. Four technological sub-fields involved in cloud services are: deployment, integration, on demand, and virtual private networks.

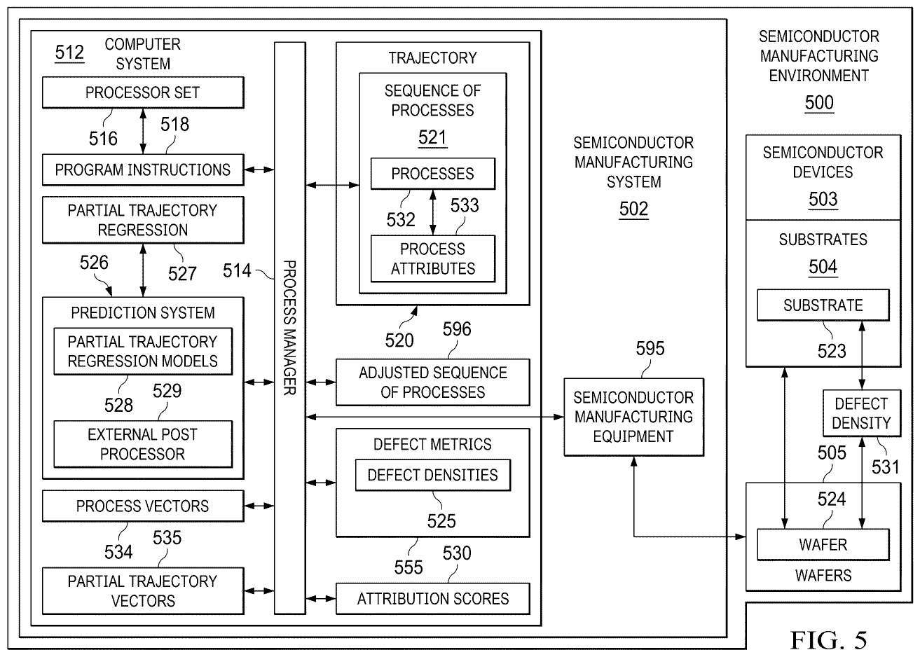

With reference now to FIG. 5, a block diagram of a semiconductor manufacturing environment is depicted in accordance with an illustrative embodiment. In this illustrative example, semiconductor manufacturing environment 500 includes components that can be implemented in hardware such as the hardware shown in computing environment 400 in FIG. 4. In this example, semiconductor manufacturing system 502 can operate to manufacture semiconductor devices 503 on substrates 504 using semiconductor manufacturing equipment 595. A semiconductor device is a component in which the properties of semiconductor materials forming a semiconductor device can be used to manipulate at least one of energy, signals, or information. The semiconductor devices can be integrated circuits, microprocessors, memories, power devices, laser diodes, image sensors, micro electric mechanical systems (MEMs), optical waveguides, and other suitable types of devices.

In these illustrative examples, substrates 504 can be comprised of a number of different types of materials. For example, materials for substrates 504 can be selected from at least one of silicon (Si), silicon on insulator (SOI), gallium arsenide (GaAs), silicon carbide (SiC0), Sapphire (Al2O3), or other suitable forms.

In this illustrative example, substrates 504 take the form of wafers 505. A wafer is a substrate in the form of a flat disk that is used for manufacturing semiconductor devices 503.

In this example, semiconductor manufacturing system 502 comprises computer system 512 and process manager 514 located in computer system 512. Process manager 514 may be implemented using semiconductor process manager 490 in FIG. 4.

Process manager 514 can be implemented in software, hardware, firmware or a combination thereof. When software is used, the operations performed by process manager 514 can be implemented in program instructions configured to run on hardware, such as a processor unit. When firmware is used, the operations performed by process manager 514 can be implemented in program instructions and data and stored in persistent memory to run on a processor unit. When hardware is employed, the hardware can include circuits that operate to perform the operations in process manager 514.

In the illustrative examples, the hardware can take a form selected from at least one of a circuit system, an integrated circuit, an application-specific integrated circuit (A SIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field-programmable logic array, a field-programmable gate array, and other suitable hardware devices. Additionally, the processes can be implemented in organic components integrated with inorganic components and can be comprised entirely of organic components excluding a human being. For example, the processes can be implemented as circuits in organic semi conductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and a number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 512 is a physical hardware system and includes one or more data processing systems. When more than one data processing system is present in computer system 512, those data processing systems are in communication with each other using a communications medium. The communications medium can be a network. The data processing systems can be selected from at least one of a computer, a server computer, a tablet computer, or some other suitable data processing system.

As depicted, computer system 512 includes processor set 516 that is capable of executing program instructions 518 implementing processes in the illustrative examples. In other words, program instructions 518 are computer-readable program instructions. Processor set 516 is an example of processor set 410 in FIG. 4.

As used herein, a processor unit in processor set 516 is a hardware device and is comprised of hardware circuits such as those on an integrated circuit that respond to and process instructions and program code that operate a computer. Processor set 516 can be a number of processor units that can be implemented using processor set 410 in FIG. 4. The processor units can also be referred to as computer processors. When processor set 516 executes program instructions 518 for a process, processor set 516 can be one or more processor units that are in the same computer or in different computers. In other words, the process can be distributed between processor units in processor set 516 on the same or different computers in computer system 512.

Further, processor set 516 can include the same type or different types of processor units. For example, processor set 516 can be selected from at least one of a single core processor, a dual-core processor, a multi-processor core, a general-purpose central processing unit (CPU), a graphics processing unit (GPU), a digital signal processor (DSP), or some other type of processor unit.

Although not shown, processor set 516 can also include other components in addition to the processor units or processing circuitry. For example, processor set 516 can also include a cache or other components used with processor units or other processing circuitry.

In one illustrative example, process manager 514 receives trajectory 520. In this example, trajectory 520 comprises a sequence of processes 521 for manufacturing semiconductor devices 503 on substrate 523 in substrates 504. In this example, substrate 523 takes the form of wafer 524 in wafers 505.

A process is a fabrication step that significantly changes the material, structure, or electrical properties of a wafer. This change to the wafer moves the wafer closer to becoming functional semiconductor devices. Further in this example, each process is made up of operations, which are specific steps that carry out the process. For example, a process can be deposition, patterning, or etching. The operations are performed to execute the process. For example, with deposition, the operations can be preclean, deposit material, and anneal.

In this illustrative example, processes 532 in sequence of processes 521 in trajectory 520 have process attributes 533. Specifically, each process in processes 532 has process attributes 533. Process attributes 533 can include at least one of a timestamp, an equipment identifier, a recipe identifier, a tool setting, a wait time, a processing time, a tool type, a photo layer identifier, a route identifier, a wafer orientation, a film composition, an annealing time, an exposure time, a deposition rate, a photoresist thickness, a resolution, an x-ray level, a doping level, a gas flow rate, or other attributes that relate to a process.

In this example, process manager 514 predicts defect metrics 555 for sequence of processes 521 in trajectory 520 using prediction system 526. In this example, prediction system 526 predicts defect metrics 555 for sequence of processes 521 in trajectory 520 using partial trajectory regression 527.

A defect metric is a measurement of a substrate such as a wafer that can be used to assess the quality of the wafer. In this example, a measurement can be made to obtain a defect metric after the process in sequence of processes 521 to obtain a defect metric for wafer 524 after performing that particular process.

In these illustrative examples, defect metrics 555 are described in the form of defect densities 525. A defect density can be the number of defects per unit area on substrate 523. For example, when substrate 523 takes the form of wafer 524, defect density 531 for wafer 524 can be measured as the number of defects per centimeter squared.

In other illustrative examples, defect metrics 555 can take other forms. For example, defect metrics 555 can also be defects per unit, defect kill ratio, defect distribution size, and other suitable metrics that provide information for assessing the quality of substrates 504.

Determining defect densities 525 present after the performance of each process in sequence of processes 521 is desired. In these examples, process manager 514 uses prediction system 526 to predict defect densities 525 for partial trajectories in the form of partial trajectories in response to receiving trajectory 520. These defect densities can be used to identify the defect density for each process in sequence of processes 521 in trajectory 520 using defect densities 525 predicted for partial trajectories using prediction system 526. For example, the defect density for a process is the defect density that is present on substrate 523 after that process has been completed. The density can be predicted for that process using partial trajectory in which the process is the last process in the sequence of processes 521. With these predictions, a measurement of substrate 523 is not needed after the completion of each process in sequence of processes 521.

In this example, process manager 514 determines attribution scores 530 for the sequence of processes 521 in trajectory 520 using defect densities 525 predicted by prediction system 526. In this example, attribution scores 530 indicate a responsibility of processes in the sequence of processes 521 for defect density 531 for substrate 523.

With attribution scores 530, process manager 514 can identify a number of processes 532 in sequence of processes 521 responsible for defect density 531 for substrate 523 when that is present after the last process is performed for substrate 523 using attribution scores 530. In this example, attribution scores 530 can be used to identify a number of processes 532 as a single process that is responsible for defect density 531. In other illustrative examples, a number of processes 532 identified can be multiple processes that are responsible for defect density 531.

In this example, prediction system 526 has been designed to perform operations that include prediction system 526 creating a vector representation of each process in the sequence of processes in the trajectory to form process vectors 534 for the trajectory. The vector representation of a process can be a numerical vector that represents attributes for that process. The attributes for the process can be, for example, an equipment identifier, a logical recipe identifier, and other suitable attributes for the process.

These operations also include prediction system 526 determining partial trajectories vectors 535 for the trajectory using process vectors 534. A nother operation includes prediction system 526 predicting the defect density 531 for each process in sequence of processes 532 using partial trajectories vectors 535 to form defect densities 525 in which defect density 531 for a process in sequence of processes 521 is predicted using a partial trajectory vector that comprises processes vectors 534 for sequence of processes 521 that are up to and including the process of interest.

In performing the operation, prediction system 526 also determines attribution scores 530 for sequence of processes 521 using defect densities 525. An attribution score in attribution scores 530 is determined for the process in the sequence of processes 521 as a difference between a first defect density predicted for a first partial trajectory up to but excluding the process and a second defect density predicted for a second partial trajectory up to and including the process.

In this example, prediction system 526 comprises a number of partial trajectory regression models 528. The number of partial trajectory regression models 528 can be comprised of at least one of sequential regression model, a neural network, recurrent neural network (RNN), a constrained neural network, a long-short term memory (LSTM) network, or a transformer model, or other suitable types of prediction models that can handle partial trajectories.

Further, prediction system 526 can also include external post processor 529. This post processor can be a machine learning model, rule based logic, a post processing engine, or other processing code or logic. This external post processor can process predictions output by the number of partial trajectory regression models 528.

For example, external post processor 529 can determine attribution scores 530 using defect densities 525 predicted for partial trajectory vectors 535 by a partial trajectory regression model in the number of partial trajectory regression models 528. In this example, external post processor 529 is outside of the partial trajectory regression model and receives defect densities 525 output by the partial trajectory regression model.

In another example, external post processor 529 can be implemented as a postprocessing layer within a partial trajectory regression model. In this case, the partial trajectory regression model outputs attribution scores 530 instead of defect densities 525.

These attribution scores can be used to perform advanced process control. For example, process manager 514 can adjust a number of process attributes 533 for the number of processes 532 in sequence of processes 521 identified as being responsible for defect density 531 to form adjusted sequence of processes 532. The particular process attributes adjusted can be process attributes that can affect a defect density resulting after the process has been performed.

This adjustment of the number of process attributes 533 can be made from analyzing the number of process attributes 533 identified as being responsible for defect density 531 to determine what changes to the number of process attributes 533 may be needed to reduce defect density 531 for substrate 523 when processing is complete. This analysis can be made by process manager 514 or with the assistance of process engineers or other persons.

Process attributes 533 adjusted in one process may be different from process attributes in another process in the number of processes 532 when more than one process is present in the number of processes 532 identified as being responsible for defect density 531. Process manager 514 can manufacture semiconductor devices 503 on substrates 504 using adjusted sequence of processes 596. This manufacturing is a practical application of at least one of predicting defect densities 525 or attribution scores 530 for trajectory 520.

In one illustrative example, one or more technical solutions are present that overcome a technical problem with identifying processes in a trajectory that are responsible for undesired levels of defect densities. As a result, one or more technical solutions may provide a technical effect providing an ability to predict defect densities that can be used to determine attribution scores for use in root cause analysis to identify one or more responsible processes in a trajectory.

Computer system 512 can be configured to perform at least one of the steps, operations, or actions described in the different illustrative examples using software, hardware, firmware or a combination thereof. As a result, computer system 512 operates as a special purpose computer system in which process manager 514 in computer system 512 enables predicting defect densities for partial trajectories using a prediction system. These predicted defect densities can then be used to determine differences in defects in a partial trajectory with a process of interest and a partial trajectory without the process of interest. These differences can be used to determine attribution scores for the processes. A practical application of this process is controlling manufacturing of semiconductor devices on wafers or other substrates using the sequential processes. In these examples, adjustments can be made to one or more processes in the sequence of processes based on the attribution scores in for the one or more processes in the process sequence that are responsible for the defect density having an undesired level. The adjusted sequence of processes can then be used to manufacture semiconductor devices on wafers with a lower level of defect densities.

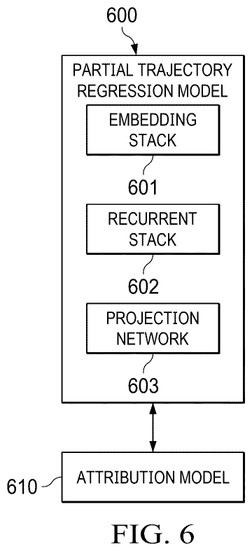

With reference next to FIG. 6, a block diagram of a partial trajectory regression model that implements partial trajectory regression is depicted in accordance with an illustrative embodiment. Partial trajectory regression model 600 is an example of a partial trajectory regression model in partial trajectory regression models 528 in FIG. 5. This partial trajectory regression model is designed to handle partial trajectories and predict defect densities for those partial trajectories. Partial trajectory regression model 600 is implemented in a manner that enables performing partial trajectory regression for partial trajectories generated from an input trajectory.

Partial trajectory regression model 600 is designed to generate predictions of defect densities for partial trajectories using partial trajectory regression. These defect densities predicted for the partial trajectories can be used to calculate an attribution score for each process in the process history for a trajectory. As depicted, partial trajectory regression model 600 is comprised of a framework that includes embedding stack 601, recurrent stack 602, and projection network 603.

Embedding stack 601 provides process embedding and is formed from one or more embedding layers. In this depicted example, embedding stack 601 receives a trajectory in the form of a string. This string describes the sequential processes and the attributes for those processes in the trajectory. Embedding stack 601 creates process vectors that represent the processes in the trajectory. Embedding stack 601 outputs a process vector representation of each process. In this illustrative example, the process vector is a numerical representation of a process and its attributes.

Embedding stack 601 can implement various processes to create process vector representations of the processes. In this example, embedding stack 601 is one or more layers and can be implemented using Proc2Vec. Embedding stack 601 can handle a diversity of trajectories and capture implicit similarities between the description of processes in trajectories.

In this illustrative example, recurrent stack 602 is one or more layers that implements a process for regression modeling using process vectors processes generated by embedding stack 601. With processes having been converted from a string form into D-dimensional vectors, a predictive model is implemented for defect density y as a function of the sequence of the process vectors. Recurrent stack 602 can handle the variable length of trajectories, making it an instance of trajectory regression distinct from current regression techniques.

Recurrent stack 602 can create partial trajectories used to predict defect densities for the partial trajectories. In these examples, partial trajectories are generated by incrementally including a next process in the sequences of processes. These partial trajectories are created using process vectors to form partial trajectory vectors.

Further, in the illustrative example, projection network 603 can include more layers. This network provides a prediction of the defect density or other defect metric based on vectors for the partial trajectories created by recurrent stack 602. Thus, projection network 603 outputs a defect density for each partial trajectory received from recurrent stack 602.

In this example, attribution model 610 is an example of external post processor 529 in FIG. 5 and can be used with partial trajectory regression model 600 to determine attribution scores for processes in a trajectory. Attribution model 610 can receive the defect densities output by projection network 603 in partial trajectory regression model 600. Attribution scores for a process can be directly calculated as the difference of defect densities between first trajectory with processes up to the process and a second trajectory with processes including the process.

The illustration of semiconductor manufacturing environment 500 in FIGS. 5-6 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, semiconductor manufacturing equipment 595 is depicted as part of semiconductor manufacturing system 502 in the illustrative examples. In other examples, semiconductor manufacturing equipment 595 can be considered a separate component from semiconductor manufacturing system 502.

In another illustrative example, process manager 514 can be a distributed process. For example, some code for process manager 514 can be located on semiconductor manufacturing equipment 595 to collect and identify defect density information. In yet another example, the processes used to train a partial trajectory regression model in partial trajectory regression models 528 can be implemented as a separate component from process manager 514.

In these examples, attribution scores 530 can be used to make adjustments to trajectory 520 prior to performing sequence of processes 521. In other examples, adjustments to sequence of processes 521 can be performed for processes 532 that have not yet been performed or completed. In other words, these determinations of attributions scores can be made in real time enabling adjustments to sequence of processes 521 to be made in real time during the manufacturing of semiconductor devices 503.

As another illustrative example, process manager 514 can be implemented in other types of manufacturing systems in addition to semiconductor manufacturing system 502. For example, a product manufacturing system comprises manufacturing equipment that operate to perform a sequence of processes to manufacture products; a prediction system trained to output attribution scores for sequences of processes in trajectories; and a controller that performs operations. The operations comprise receiving a trajectory, wherein the trajectory comprises a sequence of processes for the manufacturing equipment to manufacture a product; determining attribution scores for the sequence of processes in the trajectory using defect densities predicted by the prediction system, wherein the attribution scores indicate a responsibility of processes in the sequence of processes for a defect metric for the product; and controlling operation of the manufacturing equipment using a number of changes to the sequence of processes based on the attribution scores.

The controller can be process manager 514 in this example. The product manufacturing system can take a number of different forms. For example, the product manufacturing system can be selected from a group comprising an automobile manufacturing system, a pharmaceutical manufacturing system, a food processing system, a metal fabrication system, a plastics manufacturing system, a chemical production system, and types of systems in which metrics such as defect metrics are monitored for product quality.

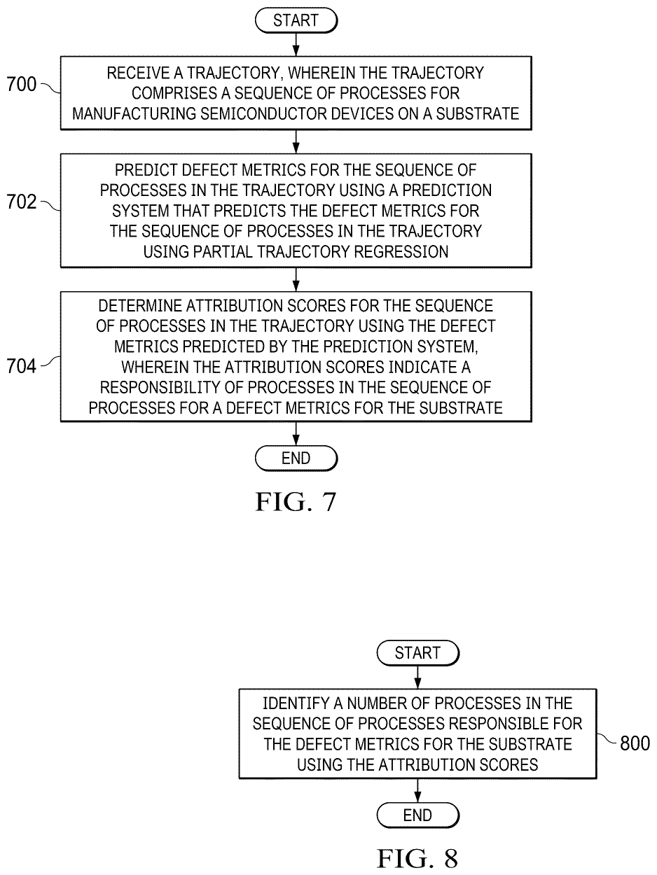

Turning next to FIG. 7, a flowchart of a process for defect attribution is depicted in accordance with an illustrative embodiment. The process in FIG. 7 can be implemented in hardware, software, or both. When implemented in software, the process can take the form of program instructions that are run by a processor set located in one or more hardware devices in one or more computer systems. For example, the process can be implemented in process manager 514 in computer system 512 in FIG. 5.

The process receives a trajectory, wherein the trajectory comprises a sequence of processes for manufacturing semiconductor devices on a substrate (step 700). The process predicts defect metrics for the sequence of processes in the trajectory using a prediction system that predicts the defect metrics for the sequence of processes in the trajectory using a partial trajectory regression (step 702).

The process determines attribution scores for the sequence of processes in the trajectory using the defect metrics predicted by the prediction system, wherein the attribution scores indicate a responsibility of processes in the sequence of processes for a defect metrics for the substrate (step 704). The process terminates thereafter.

With reference now to FIG. 8, a flowchart of a process for identifying processes responsible for defect metrics is depicted in accordance with an illustrative embodiment. The process in this flowchart is an example of an additional step taken to perform the steps in FIG. 7.

The process identifies a number of processes in the sequence of processes responsible for the defect metrics for the substrate using the attribution scores (step 800). The process terminates thereafter.

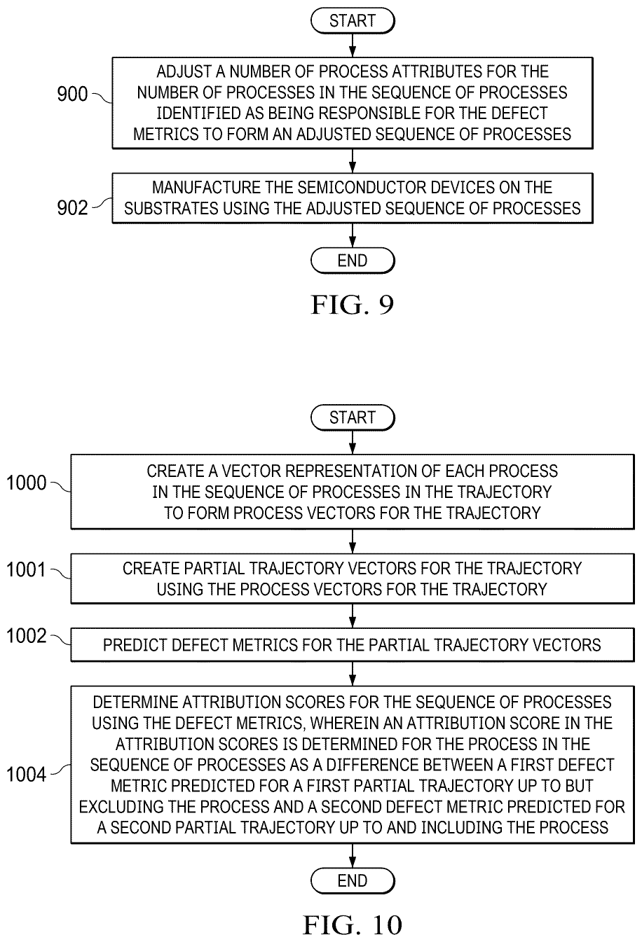

Next in FIG. 9, a flowchart of a process for adjusting manufacturing semiconductors on wafers using an adjusted process is depicted in accordance with an illustrative embodiment. The process in this flowchart is an example of an additional step taken to perform the steps in FIG. 7.

The process adjusts a number of process attributes for the number of processes in the sequence of processes identified as being responsible for the defect metrics to form an adjusted sequence of processes (step 900). The process manufactures the semiconductor devices on the substrates using the adjusted sequence of processes (step 902). The process terminates thereafter.

Turning to FIG. 10, a flowchart of a process for a partial trajectory regression model is depicted in accordance with an illustrative embodiment. The process in this flowchart is an example of operations performed by a prediction system such as prediction system 526 in FIG. 5. The steps can be performed in response to the prediction system receiving a trajectory of sequential processes used to manufacture semiconductor devices and substrates such as wafers. The process followed in this example implements partial trajectory regression 527 in FIG. 5.

The process creates a vector representation of each process in the sequence of processes in the trajectory to form process vectors for the trajectory (step 1000). The process creates partial trajectory vectors for the trajectory using the process vectors for the trajectory (step 1001). The process predicts the defect metrics for the partial trajectory vectors (step 1002).

The process determines attribution scores for the sequence of processes using the defect metrics, wherein an attribution score in the attribution scores is determined for the process in the sequence of processes as a difference between a first defect metric predicted for a first partial trajectory up to but excluding the process and a second defect metric predicted for a second partial trajectory up to and including the process (step 1004). The process terminates thereafter.

In one illustrative example, creating the vector representation and predicting the defect metric are performed by a partial trajectory regression model in the prediction system and determining attribution scores are determined by an external post processor in the prediction system. These different functions can be performed using an embedding layer and a current layer. The external post processor is outside of the partial trajectory regression model and receives the defect metrics output by the partial trajectory regression model. In another illustrative example, creating the vector, predicting the defect metric, and determining the attribution scores are performed by a partial trajectory regression model in the prediction system. With this example, the logic and postprocessing is implemented as a layer or as a part of the partial trajectory regression model.

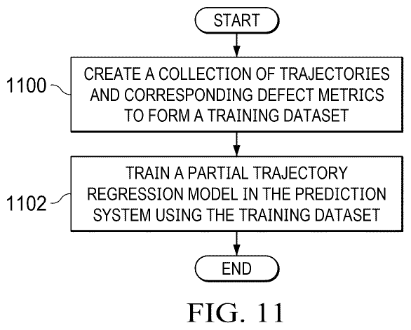

With reference to FIG. 11, a flowchart of a process for training a partial trajectory regression model to predict defect densities using partial trajectories is depicted in accordance with an illustrative environment. The process can be implemented in process manager 514 to train a partial trajectory regression model such as partial trajectory regression model 600 in FIG. 6.

The process creates a collection of trajectories and corresponding defect metrics to form a training dataset (step 1100). The process trains a partial trajectory regression model in the prediction system using the training dataset (step 1102). The process terminates thereafter.

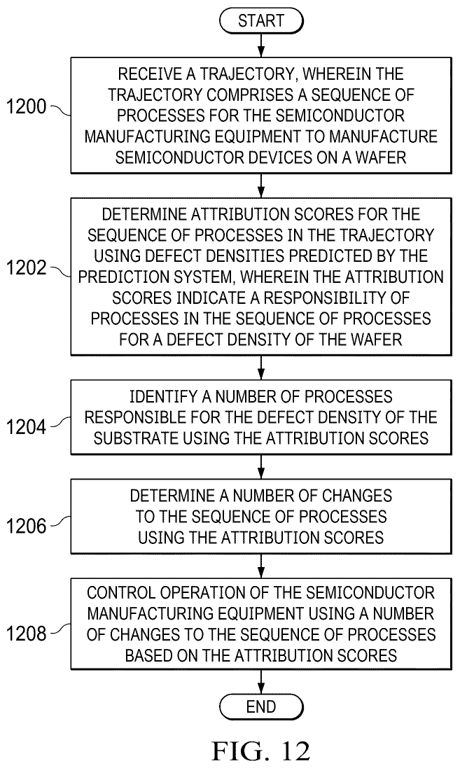

Turning next to FIG. 12, a flowchart of a process for controlling semiconductor manufacturing equipment is depicted in accordance with an illustrative embodiment. The process in FIG. 12 can be implemented in hardware, software, or both. When implemented in software, the process can take the form of program instructions that are run by a processor set located in one or more hardware devices in one or more computer systems. For example, the process can be implemented in process manager 514 in computer system 512 in FIG. 5.

The process receives a trajectory, wherein the trajectory comprises a sequence of processes for the semiconductor manufacturing equipment to manufacture semiconductor devices on a wafer (step 1200). The process determines attribution scores for the sequence of processes in the trajectory using defect densities predicted by the prediction system, wherein the attribution scores indicate a responsibility of processes in the sequence of processes for a defect density of the wafer (step 1202).

The process identifies a number of processes responsible for the defect density of the substrate using the attribution scores (step 1204).

The process determines a number of changes to the sequence of processes using the attribution scores (step 1206). The process controls operation of the semiconductor manufacturing equipment using a number of changes to the sequence of processes based on the attribution scores (step 1208). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program instructions, hardware, or a combination of the program instructions and hardware. When implemented in hardware, the hardware may, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

According to one illustrative embodiment, a computer system is provided that comprises a processor set, a set of one or more computer-readable storage media, and program instructions stored in the set of one or more storage media. The program instructions cause the process set to receive a trajectory, wherein the trajectory comprises a sequence of processes for manufacturing semiconductor devices on a substrate. The program instructions cause the process set to predict defect metrics for the sequence of processes in the trajectory using a prediction system that predicts the defect metrics for the sequence of processes in the trajectory using a partial trajectory regression. The program instructions cause the process set to determine attribution scores for the sequence of processes in the trajectory using the defect metrics predicted by the prediction system, wherein the attribution scores indicate a responsibility of processes in the sequence of processes for a defect metric for the substrate. As a result, the illustrative embodiments provide a technical effect of enabling root cause analysis to identify a number of processes in the sequences of processes as being responsible for the defect metric for the substrate.

In the illustrative embodiments, the processor set identifies a number of processes in the sequence of processes responsible for the defect metric for the substrate using the attribution scores. Thus, the illustrative embodiments provide a technical effect of identifying a number of processes responsible for the defect metric for the substrate.

In the illustrative embodiments, the processor set performs advanced process control. Thus, the illustrative embodiments provide a technical effect of enabling advanced process control.

In the illustrative embodiments, the processor set adjust a number of process attributes for the number of processes in the sequence of processes identified as being responsible for the defect metric to form an adjusted sequence of processes. The processor set manufactures the semiconductor devices on the substrates using the adjusted sequence of processes. As a result, the illustrative embodiments provide a technical effect of reducing defect metrics in manufacturing the semiconductor devices on the substrates.

In the illustrative embodiments, the prediction system has been trained to perform the operations. The prediction system has been trained to create a vector representation of each process in the sequence of processes in the trajectory to form process vectors for the trajectory. The prediction system has been trained to create partial trajectory vectors for the trajectory using the process vectors for the trajectory. The prediction system has been trained to predict the defect metrics for the partial trajectory vectors. The prediction system has been trained to determine attribution scores for the sequence of processes using the defect metrics, wherein an attribution score in the attribution scores is determined for the process in the sequence of processes as a difference between a first defect metric predicted for a first partial trajectory up to but excluding the process and a second defect metric predicted for a second partial trajectory up to and including the process. Thus, the illustrative embodiments provide a technical effect of using a prediction system to determine attribution scores used to identify a number of processes responsible for a defect metric for the substrate.

In the illustrative embodiments, creating the vector representation and predicting the defect metrics are performed by a partial trajectory regression model in the prediction system and wherein determining attribution scores is determined by an external post processor in the prediction system. The external post processor is outside of the partial trajectory regression model and receives the defect metrics output by the partial trajectory regression model. Thus, the illustrative embodiments provide a technical effect of determining attribution scores using a prediction model and an external post processor.

In the illustrative embodiments, creating the vector, predicting the defect metrics, and determining the attribution scores are performed by a partial trajectory regression model in the prediction system. As a result, the illustrative embodiments provide a technical effect of determining attribution scores using a partial trajectory regression model.

In the illustrative embodiments, a partial trajectory regression model in the prediction system comprises an embedding layer that receives the trajectory and creates process vectors from the processes in the trajectory; a regression layer that receives the process vectors from the embedding layer and creates partial trajectory vectors from the process vectors; and projection layer that outputs defect metrics for the partial trajectory vectors. Thus, the illustrative embodiments enable predicting defect metrics using partial trajectory regression model having an embedding layer, a regression layer, and a projection layer.

According to another illustrative embodiment, a semiconductor manufacturing system comprises semiconductor manufacturing equipment that operate to perform a sequence of processes; a prediction system trained to output attribution scores for sequences of processes in trajectories; and a controller that performs operations. The controller receives a trajectory, wherein the trajectory comprises a sequence of processes for the semiconductor manufacturing equipment to manufacture semiconductor devices on a wafer. The controller determines attribution scores for the sequence of processes in the trajectory using defect densities predicted by the prediction system, wherein the attribution scores indicate a responsibility of processes in the sequence of processes for a defect density of the wafer. The controller controls operation of the semiconductor manufacturing equipment using a number of changes to the sequence of processes based on the attribution scores. Thus, the illustrative embodiments provide a technical effect of controlling operation of manufacturing equipment using one or more changes based on attributions scores predicted using a prediction system.

In the illustrative embodiments, the prediction system has been trained to perform the operations. The prediction system creates a vector representation of each process in the sequence of processes in the trajectory to form process vectors for the trajectory. The prediction system determines partial trajectory vectors for the trajectory using the process vectors for the trajectory. The prediction system determines the defect densities for the partial trajectory vectors. The prediction system determines attribution scores for the sequence of processes using the defect densities, wherein an attribution score in the attribution scores is determined for the process in the sequence of processes as a difference between a first defect density predicted for a first partial trajectory up to but excluding the process and a second defect density predicted for a second partial trajectory up to and including the process. Thus, the illustrative embodiments provide a technical effect of using a prediction system to determine attribution scores used to identify a number of processes responsible for a defect metric for the substrate.

In the illustrative embodiments, creating the vector representation and predicting the defect densities are performed by a partial trajectory regression model in the prediction system and wherein determining attribution scores is determined by an external post processor in the prediction system. The external post processor is outside of the partial trajectory regression model and receives the defect densities output by the partial trajectory regression model. Thus, the illustrative embodiments provide a technical effect of determining attribution scores using a prediction model and an external post processor.

In the illustrative embodiments, creating the vector representation, predicting the defect densities, and determining the attribution scores are performed by a partial trajectory regression model in the prediction system. As a result, the illustrative embodiments provide a technical effect of determining attribution scores using a partial trajectory regression model and an external post processor.

A method predicts defect metrics. The method receives a trajectory, wherein the trajectory comprises a sequence of processes for manufacturing semiconductor devices on a substrate. The method predicts defect metrics for the sequence of processes in the trajectory using a prediction system that predicts the defect metrics for the sequence of processes in the trajectory using a partial trajectory regression. The method determines attribution scores for the sequence of processes in the trajectory using the defect metrics predicted by the prediction system, wherein the attribution scores indicate a responsibility of processes in the sequence of processes for a defect metric for the substrate. As a result, the illustrative embodiments provide a technical effect of enabling root cause analysis to identify a number of processes in the sequences of processes as being responsible for the defect metric for the substrate.

In the illustrative embodiments, the method identifies a number of processes in the sequence of processes responsible for the defect metric for the substrate using the attribution scores. Thus, the illustrative embodiments provide a technical effect of identifying a number of processes responsible for the defect metric for the substrate.

In the illustrative embodiments, the method adjusts a number of process attributes for the number of processes in the sequence of processes identified as being responsible for the defect metric to form an adjusted sequence of processes. The method manufactures the semiconductor devices on the substrates using the adjusted sequence of processes. As a result, the illustrative embodiments provide a technical effect of reducing defect metrics in manufacturing the semiconductor devices on the substrates.

In the illustrative embodiments, the prediction system has been trained to perform operations. The prediction system creates a vector representation of each process in the sequence of processes in the trajectory to form process vectors for the trajectory. The prediction system creates partial trajectory vectors for the trajectory using the process vectors for the trajectory. The prediction system predicts the defect metrics for the partial trajectory vectors. The prediction system determines attribution scores for the sequence of processes using the defect metrics, wherein an attribution score in the attribution scores is determined for the process in the sequence of processes as a difference between a first defect metric predicted for a first partial trajectory up to but excluding the process and a second defect metric predicted for a second partial trajectory up to and including the process. Thus, the illustrative embodiments provide a technical effect of using a prediction system to determine attribution scores used to identify a number of processes responsible for a defect metric for the substrate.

In the illustrative embodiments, creating the vector representation, creating the partial trajectories, and predicting the defect metrics are performed by a partial trajectory regression model in the prediction system and wherein determining attribution scores is determined by an external post processor in the prediction system. The external post processor is outside of the partial trajectory regression model and receives the defect metrics output by the partial trajectory regression model. Thus, the illustrative embodiments provide a technical effect of determining attribution scores using a partial trajectory regression model and an external post processor.

In the illustrative embodiments, creating the vector, creating the partial trajectory vectors, predicting the defect metrics, and determining the attribution scores are performed by a partial trajectory regression model in the prediction system. As a result, the illustrative embodiments provide a technical effect of determining attribution scores using a partial trajectory regression model.

In the illustrative embodiments, the method creates a collection of trajectories and corresponding defect metrics to form a training dataset. The method trains a partial trajectory regression model in the prediction system using the training dataset. As a result, the illustrative embodiments provide a technical effect of training a partial trajectory regression model using trajectories and corresponding defect metrics.

A computer program product predicts defect metrics. The computer program product comprises a set of one or more computer-readable storage media; and program instructions stored on the set of one or more storage media to perform operations. The program instructions cause a processor set to receive a trajectory, wherein the trajectory comprises a sequence of processes for manufacturing semiconductor devices on a substrate. The program instructions cause the processor set to predict defect metrics for the sequence of processes in the trajectory using a prediction system that predicts the defect metrics for the sequence of processes in the trajectory using a partial trajectory regression. The program instructions cause the processor set to determine attribution scores for the sequence of processes in the trajectory using the defect metrics predicted by the prediction system, wherein the attribution scores indicate a responsibility of processes in the sequence of processes for a defect metric for the substrate. As a result, the illustrative embodiments provide a technical effect of enabling root cause analysis to identify a number of processes in the sequences of processes as being responsible for the defect metric for the substrate.

In the illustrative embodiments, the program instructions cause the processor set to identify a number of processes in the sequence of processes responsible for the defect metric for the substrate using the attribution scores. Thus, the illustrative embodiments provide a technical effect of identifying a number of processes responsible for the defect metric for the substrate.

In the illustrative embodiments, the program instructions cause the processor set to adjust a number of process attributes for the number of processes in the sequence of processes identified as being responsible for the defect metric to form an adjusted sequence of processes. The program instructions cause the processor set to manufacture the semiconductor devices on the substrates using the adjusted sequence of processes. As a result, the illustrative embodiments provide a technical effect of reducing defect metrics in manufacturing the semiconductor devices on the substrates.

In the illustrative embodiments, the prediction system has been trained to perform operations. The prediction system creates a vector representation of each process in the sequence of processes in the trajectory to form process vectors for the trajectory. The prediction system creates partial trajectory vectors for the trajectory using the process vectors for the trajectory. The prediction system predicts the defect metrics for the partial trajectory vectors. The prediction system determines attribution scores for the sequence of processes using the defect metrics, wherein an attribution score in the attribution scores is determined for the process in the sequence of processes as a difference between a first defect metric predicted for a first partial trajectory up to but excluding the process and a second defect metric predicted for a second partial trajectory up to and including the process. Thus, the illustrative embodiments provide a technical effect of using a prediction system to determine attribution scores used to identify a number of processes responsible for a defect metric for the substrate.

In the illustrative embodiments, creating the vector representation, creating the partial trajectories, and predicting the defect metrics are performed by a partial trajectory regression model in the prediction system and wherein determining attribution scores is determined by an external post processor in the prediction system. The external post processor is outside of the partial trajectory regression model and receives the defect metrics output by the partial trajectory regression model. Thus, the illustrative embodiments provide a technical effect of determining attribution scores using a partial trajectory regression model and an external post processor.

A product manufacturing system comprising manufacturing equipment that operate to perform a sequence of processes to manufacture products; a prediction system trained to output attribution scores for sequences of processes in trajectories; and a controller that performs operations. The controller receives a trajectory, wherein the trajectory comprises a sequence of processes for the manufacturing equipment to manufacture a product. The controller determines attribution scores for the sequence of processes in the trajectory using defect metrics predicted by the prediction system, wherein the attribution scores indicate a responsibility of processes in the sequence of processes for a defect metric for the product. The controller controls operation of the manufacturing equipment using a number of changes to the sequence of processes based on the attribution scores. Thus, the illustrative embodiments provide a technical effect of controlling operation of manufacturing equipment using one or more changes based on attributions scores predicted using a prediction system]

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer system comprising:
a processor set;
a set of one or more computer-readable storage media; and
program instructions stored in the set of one or more storage media to cause the processor set to perform operations comprising:
receiving a trajectory, wherein the trajectory comprises a sequence of processes for manufacturing semiconductor devices on a substrate;
predicting defect metrics for the sequence of processes in the trajectory using a prediction system that predicts the defect metrics for the sequence of processes in the trajectory using a partial trajectory regression; and
determining attribution scores for the sequence of processes in the trajectory using the defect metrics predicted by the prediction system, wherein the attribution scores indicate a responsibility of processes in the sequence of processes for a defect metric for the substrate.

2. The computer system of claim 1, wherein the operations further comprise:
identifying a number of processes in the sequence of processes responsible for the defect metric for the substrate using the attribution scores.

3. The computer system of claim 2, wherein the operations further comprise:
performing advanced process control.

4. The computer system of claim 2, wherein the operations further comprise:
adjusting a number of process attributes for the number of processes in the sequence of processes identified as being responsible for the defect metric to form an adjusted sequence of processes; and
manufacturing the semiconductor devices on the substrates using the adjusted sequence of processes.

5. The computer system of claim 1, wherein the prediction system has been trained to perform the operations comprising:
creating a vector representation of each process in the sequence of processes in the trajectory to form process vectors for the trajectory;
creating partial trajectory vectors for the trajectory using the process vectors for the trajectory;
predicting the defect metrics for the partial trajectory vectors; and
determining attribution scores for the sequence of processes using the defect metrics, wherein an attribution score in the attribution scores is determined for the process in the sequence of processes as a difference between a first defect metric predicted for a first partial trajectory up to but excluding the process and a second defect metric predicted for a second partial trajectory up to and including the process.

6. The computer system of claim 5, wherein creating the vector representation and predicting the defect metrics are performed by a partial trajectory regression model in the prediction system and wherein determining attribution scores is determined by an external post processor in the prediction system, wherein the external post processor is outside of the partial trajectory regression model and receives the defect metrics output by the partial trajectory regression model.

7. The computer system of claim 5, wherein creating the vector, predicting the defect metrics, and determining the attribution scores are performed by a partial trajectory regression model in the prediction system.

8. The computer system of claim 1, wherein a partial trajectory regression model in the prediction system comprises:
an embedding layer that receives the trajectory and creates process vectors from the processes in the trajectory;
a regression layer that receives the process vectors from the embedding layer and creates partial trajectory vectors from the process vectors; and
projection layer that outputs defect metrics for the partial trajectory vectors.

9. A semiconductor manufacturing system comprising:
semiconductor manufacturing equipment that operate to perform a sequence of processes;
a prediction system trained to output attribution scores for sequences of processes in trajectories; and
a controller that performs operations comprising:
receiving a trajectory, wherein the trajectory comprises a sequence of processes for the semiconductor manufacturing equipment to manufacture semiconductor devices on a wafer;
determining attribution scores for the sequence of processes in the trajectory using defect densities predicted by the prediction system, wherein the attribution scores indicate a responsibility of processes in the sequence of processes for a defect density of the wafer; and
controlling operation of the semiconductor manufacturing equipment using a number of changes to the sequence of processes based on the attribution scores.

10. The semiconductor manufacturing system of claim 9, wherein the prediction system has been trained to perform the operations comprising:
creating a vector representation of each process in the sequence of processes in the trajectory to form process vectors for the trajectory;
determining partial trajectory vectors for the trajectory using the process vectors for the trajectory;
determining the defect densities for the partial trajectory vectors; and
determining attribution scores for the sequence of processes using the defect densities, wherein an attribution score in the attribution scores is determined for the process in the sequence of processes as a difference between a first defect density predicted for a first partial trajectory up to but excluding the process and a second defect density predicted for a second partial trajectory up to and including the process.

11. The semiconductor manufacturing system of claim 9, wherein creating the vector representation and predicting the defect densities are performed by a partial trajectory regression model in the prediction system and wherein determining attribution scores is determined by an external post processor in the prediction system, wherein the external post processor is outside of the partial trajectory regression model and receives the defect densities output by the partial trajectory regression model.

12. The semiconductor manufacturing system of claim 10, wherein creating the vector representation, predicting the defect densities, and determining the attribution scores are performed by a partial trajectory regression model in the prediction system.

13. A method for predicting defect metrics comprising:
receiving a trajectory, wherein the trajectory comprises a sequence of processes for manufacturing semiconductor devices on a substrate; and
predicting defect metrics for the sequence of processes in the trajectory using a prediction system that predicts the defect metrics for the sequence of processes in the trajectory using a partial trajectory regression; and
determining attribution scores for the sequence of processes in the trajectory using the defect metrics predicted by the prediction system, wherein the attribution scores indicate a responsibility of processes in the sequence of processes for a defect metric for the substrate.

14. The method of claim 13 further comprising:
identifying a number of processes in the sequence of processes responsible for the defect metric for the substrate using the attribution scores.

15. The method of claim 14 further comprising:
adjusting a number of process attributes for the number of processes in the sequence of processes identified as being responsible for the defect metric to form an adjusted sequence of processes; and
manufacturing the semiconductor devices on the substrates using the adjusted sequence of processes.

16. The method of claim 13, wherein the prediction system has been trained to perform operations comprising:
creating a vector representation of each process in the sequence of processes in the trajectory to form process vectors for the trajectory;
creating partial trajectory vectors for the trajectory using the process vectors for the trajectory;
predicting the defect metrics for the partial trajectory vectors; and
determining attribution scores for the sequence of processes using the defect metrics, wherein an attribution score in the attribution scores is determined for the process in the sequence of processes as a difference between a first defect metric predicted for a first partial trajectory up to but excluding the process and a second defect metric predicted for a second partial trajectory up to and including the process.

17. The method of claim 16, wherein creating the vector representation, creating the partial trajectories, and predicting the defect metrics are performed by a partial trajectory regression model in the prediction system and wherein determining attribution scores is determined by an external post processor in the prediction system, wherein the external post processor is outside of the partial trajectory regression model and receives the defect metrics output by the partial trajectory regression model.

18. The method of claim 17, wherein creating the vector, creating the partial trajectory vectors, predicting the defect metrics, and determining the attribution scores are performed by a partial trajectory regression model in the prediction system.

19. The method of claim 13, further comprising:
creating a collection of trajectories and corresponding defect metrics to form a training dataset; and
training a partial trajectory regression model in the prediction system using the training dataset.

20. A computer program product for predicting defect metrics, the computer program product comprising:
a set of one or more computer-readable storage media; and
program instructions stored on the set of one or more storage media to perform operations comprising:
receiving a trajectory, wherein the trajectory comprises a sequence of processes for manufacturing semiconductor devices on a substrate;
predicting defect metrics for the sequence of processes in the trajectory using a prediction system that predicts the defect metrics for the sequence of processes in the trajectory using a partial trajectory regression; and
determining attribution scores for the sequence of processes in the trajectory using the defect metrics predicted by the prediction system, wherein the attribution scores indicate a responsibility of processes in the sequence of processes for a defect metric for the substrate.

21. The computer program product of claim 20, wherein the operations further comprise:
identifying a number of processes in the sequence of processes responsible for the defect metric for the substrate using the attribution scores.

22. The computer program product of claim 20 wherein the operations further comprise:
adjusting a number of process attributes for the number of processes in the sequence of processes identified as being responsible for the defect metric to form an adjusted sequence of processes; and
manufacturing the semiconductor devices on the substrates using the adjusted sequence of processes.

23. The computer program product of claim 20, wherein the prediction system has been trained to perform operations comprising:
creating a vector representation of each process in the sequence of processes in the trajectory to form process vectors for the trajectory;
creating partial trajectory vectors for the trajectory using the process vectors for the trajectory;
predicting the defect metrics for the partial trajectory vectors; and
determining attribution scores for the sequence of processes using the defect metrics, wherein an attribution score in the attribution scores is determined for the process in the sequence of processes as a difference between a first defect metric predicted for a first partial trajectory up to but excluding the process and a second defect metric predicted for a second partial trajectory up to and including the process.

24. The computer program product of claim 23, wherein creating the vector representation, creating the partial trajectories, and predicting the defect metrics are performed by a partial trajectory regression model in the prediction system and wherein determining attribution scores is determined by an external post processor in the prediction system, wherein the external post processor is outside of the partial trajectory regression model and receives the defect metrics output by the partial trajectory regression model.

25. A product manufacturing system comprising:
manufacturing equipment that operate to perform a sequence of processes to manufacture products;
a prediction system trained to output attribution scores for sequences of processes in trajectories; and
a controller that performs operations comprising:
receiving a trajectory, wherein the trajectory comprises a sequence of processes for the manufacturing equipment to manufacture a product;
determining attribution scores for the sequence of processes in the trajectory using defect metrics predicted by the prediction system, wherein the attribution scores indicate a responsibility of processes in the sequence of processes for a defect metric for the product; and
controlling operation of the manufacturing equipment using a number of changes to the sequence of processes based on the attribution scores.
